(19) United States
(12) Patent Application Publication
(10) Pub. No.: US 2012/0179755 A1
(43) Pub. Date: Jul. 12, 2012

(54) Deliberative Polling Incorporating Ratings By A Random Sample

(76) Inventors: James S. Fishkin, Stanford, CA (US); Robert E.F. Fishkin, Stanford, CA (US); Benjamin Ethan Taitelbaum, Charlottesville, VA (US); Jessica Margolin, San Francisco, CA (US)

(21) Appl. No.: 13/337,957

(22) Filed: Dec. 27, 2011

Related U.S. Application Data
(60) Provisional application No. 61/460,112, filed on Dec. 27, 2010.

(51) Int. Cl. G06F 15/16

(52) U.S. Cl. 709/204

(57) ABSTRACT

System and method facilitating group discussion of a body of information, wherein the general population of the group can comment on the information, and wherein a sample of the population rates the comments of the general population. This can reduce the disproportional effects of a highly mobilized faction on a deliberative process. According to some aspects, a second rating can be provided by members of the general population. This can be used to communicate or quantify the effects of disproportionate mobilization. Optionally, comments can be moderated to reduce the information burden on the deliberation due to excessive low-quality commenting. Expert comments can also be incorporated to better inform the general population on a topic, facilitating a more efficient process. The system and method may be implemented as an interactive web forum or debate.

### CROSS-REFERENCE TO RELATED APPLICATIONS

This patent application claims the benefit of, under Title 35, United States Code, Section 119(e), U.S. Provisional Patent Application No. 61/460,112, filed Dec. 27, 2010, the content of which is incorporated herein by reference.

### FIELD OF THE INVENTION

The invention relates to systems and methods for decision-making, and more specifically to a system and method for deliberative decision-making incorporating ratings by a random sample.

### BACKGROUND OF THE INVENTION

Examples of group decision making can be found in all areas of society. In general, one might expect decisions made by a group to be more effective, due to the leveraging of synergies among the group members. However, there are situations where the effectiveness of group decision making is compromised.

Group decision making can take place in the context of a simple in-person debate, or via online interactive venues such as e-mail, online forums, collaboratively edited documents, and so forth. More advanced forms of group decision making incorporate mechanisms for encouraging informed decision making, such as Deliberative Polling, and similar techniques.

However, these forms of deliberation can suffer from biasing effects which can arise due to the disproportional mobilization of a small faction among a population.

For example, in an online crowd-sourced forum, when everyone is invited to rate comments, the results are vulnerable to manipulation by a highly mobilized, marginal group. An example: when the GOP sought to consult Americans about their suggestions for policies nationally, one of the top rated suggestions in America Speaking Out was that the United States should replace the military with the Monty Python Knights of the Holy Grail. Obviously the process was gamed by pranksters.

Clearly, this approach suffers from the possibility that the contributions of a small but highly mobilized faction within a population can have a disproportionate impact on the decision making process by hijacking the debate from portions of the population having legitimate views but lower mobilization. A process that can be manipulated just with mobilized voting is not one that can be trusted.

It is therefore desired to provide a system and method for online discussion and decision making that mitigates the skewing effect of highly mobilized groups.

### SUMMARY OF THE INVENTION

Accordingly, it is an object of the invention to provide a system and method facilitating group discussion of a body of information, wherein the general population of the group can comment on the information, and wherein a sample of the population rates the comments of the general population.

It is another object of the invention to provide a system and method facilitating group discussion of a body of information, wherein the general population of the group can comment on the information, wherein experts can comment on the information, and wherein a sample of the population rates the comments of the general population, reducing the effects of disproportionate mobilization and facilitating ideation, i.e., the generation of new ideas which can be tested in further discussions, such as a Deliberative Poll.

It is a further object of the invention to provide a system and method facilitating group discussion of a body of information, wherein the general population of the group can comment on the information, and wherein both the general population and a sample of the population can provide a rating of the comments of the general population, reducing the effects of disproportionate mobilization and facilitating ideation.

It is yet another object of the invention to provide a system and method facilitating group discussion of a body of information, wherein the general population of the group can comment on the information, and wherein trained moderators moderate the comments, reducing the effects of disproportionate mobilization and facilitating ideation.

These and other objectives are achieved by providing a method for reducing the impact of a disproportionally mobilized faction on a deliberative process by providing a server comprising a processor and connected to a communications network; providing information to a population, via software executing on the server, over the communications network; receiving comments relating to the information from members of the population, via software executing on the server, over the communications network; providing the comments to the population, via software executing on the server, over the communications network; identifying a sample of the population; receiving ratings of the comments from members of the sample, via software executing on the server, over the communications network; and, providing the ratings to the population, via software executing on the server, over the communications network.

In some embodiments, the ratings are priority ratings, and/or may relate to the relevance or quality of the comments. In some embodiments, the sample is a randomized sample, and generating the sample may be performed via software executing on the server. The communications network may be the internet, and information, comments, and ratings may be provided to and received from the population, sample, experts, moderators, and others using an interactive webpage. The information may be a document, for example, containing various proposals, and optionally arguments for and against the proposals. The comments may be related visually or otherwise to each proposal, argument, or other section of the document.

Other objects of the present invention are achieved by providing a system for reducing the impact of a disproportionally mobilized faction on a deliberative process, having a computer communications network; a computing device having a processor, the computing device being connected to the computer network; information transmission software executing on the processor, providing information to a population, via the computer network; comments receiving software executing on the processor, receiving comments from members of the population relating to the information, via the computer network; sampling software executing on the processor, identifying a sample of the population; comments transmission software executing on the processor, transmitting the comments to the sample, via the computer network; ratings receiving software executing on the processor, receiving ratings of the comments by the sample, via the computer network; and, ratings transmission software executing on the processor, transmitting the ratings to the population, via the computer network.

In some embodiments, comments are moderated prior to transmitting the comments to the sample. Experts may also provide comments relating to the information via the network, and a population rating may also be received and transmitted by the system. In other embodiments, comments and ratings are received and transmitted continuously in real time via a web interface during the deliberative process. In further embodiments, polling software may poll the population before and/or after the deliberative process.

Other objects of the invention and its particular features and advantages will become more apparent from consideration of the following drawings and accompanying detailed description.

### BRIEF DESCRIPTION OF THE DRAWINGS

FIG. 1 is a block diagram of an example system according to aspects of the invention.

FIG. 2 is a block diagram of another example system according to aspects of the invention.

FIG. 3 is a block diagram of a further example system according to aspects of the invention.

FIG. 4 is an illustration of an example information and comment interface display according to aspects of the invention.

FIG. 5 is an illustration of an example comment and rating interface display according to aspects of the invention.

FIG. 6 is a block diagram of an example method according to aspects of the invention.

FIG. 7 is a block diagram of another example method according to aspects of the invention.

### DETAILED DESCRIPTION OF THE INVENTION

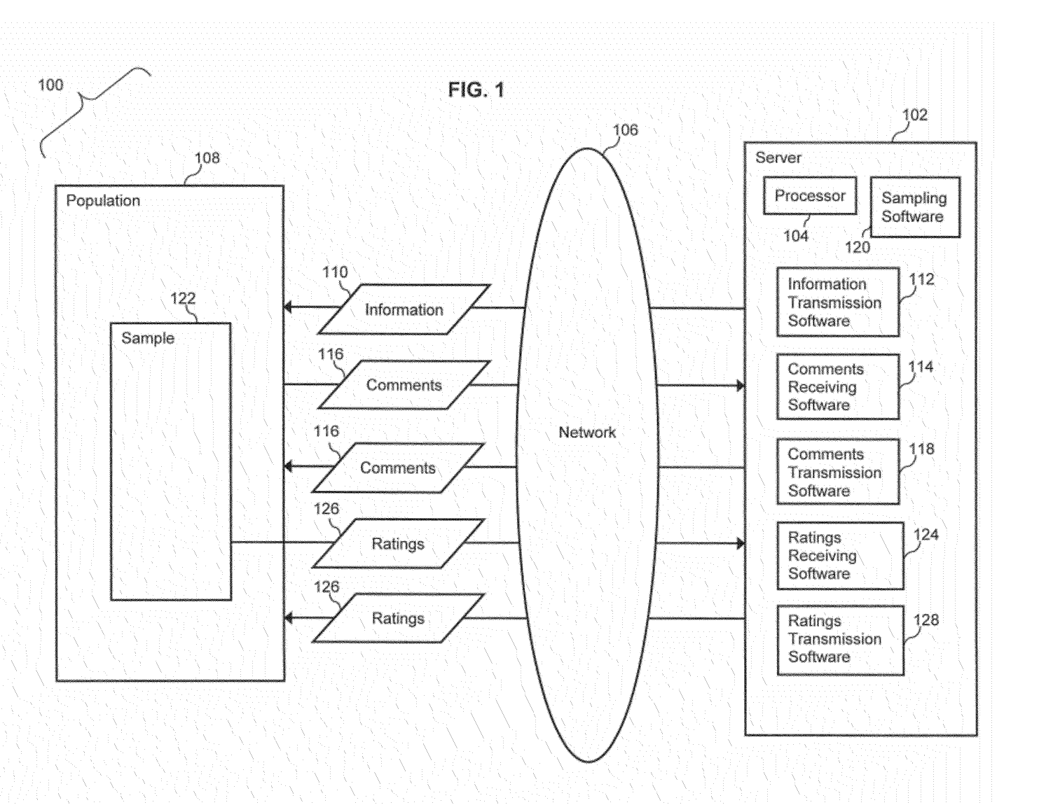

FIG. 1 illustrates an example system 100 according to aspects of the invention.

System 100 includes a server 102 connected to a communications network 106. Server 102 comprises one or more computing devices having at least one processor 104, and one or more databases (not shown) embodied as hard disk drives, flash memory drives, storage arrays, or the like. The server 102 is accessible over a communications network 106, such as the Internet, by one or more client computers (not shown). It will be understood by those having skill in the art that variations of this arrangement can be used to construct system 100.

Server 102 operates to provide access by a population 108 to information 110 using the one or more client computers (not shown), via network 106. Information 110 may be any information that can be the subject of debate. In one illustrative example according to the invention, information 110 includes a briefing document which contains one or more proposals for debate, and may contain arguments in favor of or against these proposals.

Information transmission software 112 executing on processor 104 operates to transmit the information 110 to the population 108 via network 106.

Comments receiving software 114 executing on processor 104 operates to receive comments 116 from members of the population 108 regarding information 110 via network 106. Optionally, the comments 116 may pertain to the information 110, and may be related to specific portions of the information through the operation of comments receiving software 116 or other software (not shown) executing on processor 104. For example, a particular comment may be related to a particular proposal, or to a particular argument for or against a proposal, or may be addressed generally to the information or to portions or sections of the information 110.

Comments transmission software 118 executing on processor 104 operates to transmit comments 116 to all members of the population 108 via network 106.

Sampling software 120 executing on processor 104 operates to identify a sample 122 from among the population 108 via network 106. Sample 122 is a subset of population 108 and may represent a randomized sample. Optionally, sample 122 is calculated using simple random sampling, or other suitable sampling methods known in the art. Alternatively, the sample may be identified manually, or through other means.

Ratings receiving software 124 executing on processor 104 operates to receive ratings 126 from members of the sample 122 regarding comments 116 via network 106. Optionally, ratings 126 assign a priority to one or more of the comments 116 and may relate to the relevance, credibility, or other qualities of a given comment.

Ratings transmission software 128 executing on processor 104 operates to transmit the ratings 126 to the population 108 via network 106.

Using a randomized sample of a larger population to rate the commentary of the entire population in the manner of system 100 can have the advantage of allowing all members of the population to be heard in a debate, while keeping the representativeness of their views in perspective.

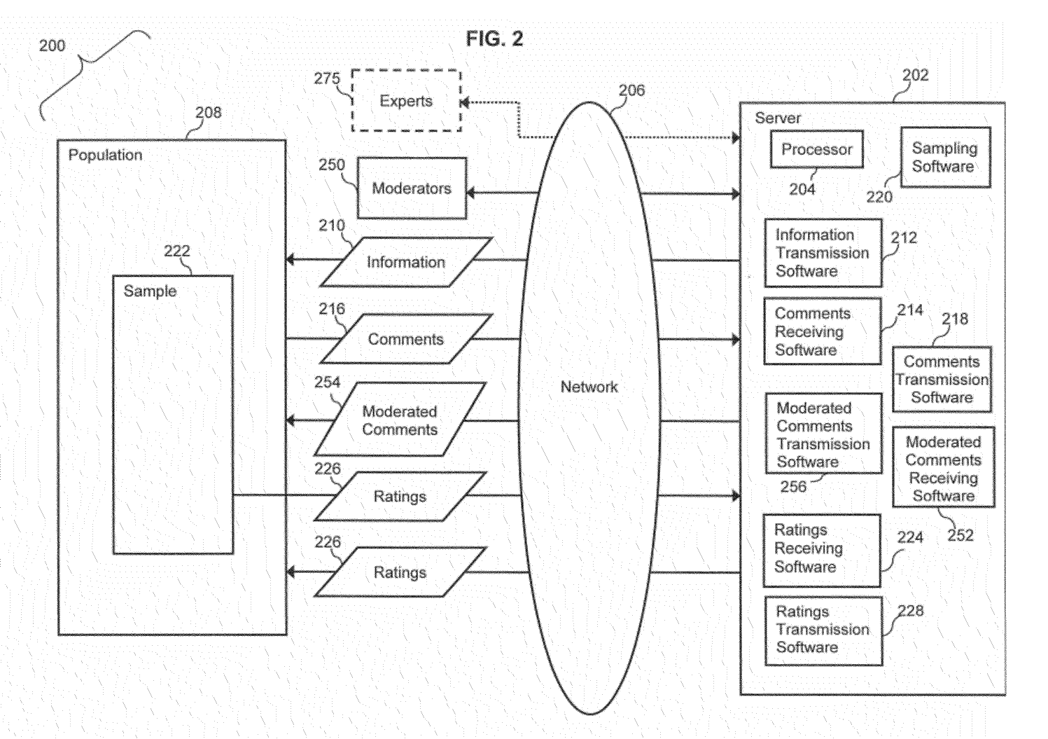

FIG. 2 illustrates an example system 200 according to aspects of the invention. System 200 is similar to system 100, except in that it incorporates comment moderation, as well as expert commenting.

System 200 includes a server 202 connected to a computer communications network 206. Server 202 comprises one or more computing devices having at least one processor 204, and one or more databases (not shown) embodied as hard disk drives, flash memory drives, storage arrays, and the like. The server 202 is accessible over a communications network 206, such as the internet, by one or more client computers (not shown). It will be understood by those having skill in the art that variations of this arrangement can be used to construct system 200.

Server 202 operates to provide access by a population 208 to information 210 using the one or more client computers (not shown), via network 206. Information 210 may be any information that can be the subject of debate. In one illustrative example according to the invention, information 210 includes a briefing document which contains one or more proposals for debate, and may contain arguments in favor of or against these proposals.

Information transmission software 212 executing on processor 204 operates to transmit the information 210 to the population 208 via network 206. Optionally, information transmission software 212 also transmits the information 210 to experts 275, who may be distinct from the population 208.

Comments receiving software 214 executing on processor 204 operates to receive comments 216 from members of the population 208 regarding information 210 via network 206. Optionally, the comments 216 may pertain to the information 210, and may be related to specific portions of the information through the operation of comments receiving software 214 or other software (not shown) executing on processor 204. For example, a particular comment may be related to a particular proposal, or to a particular argument for or against a proposal, or may be addressed generally to the information or to portions or sections of the information 210. Optionally, comments may also be received from experts 275.

Comments transmission software 218 executing on processor 204 operates to transmit comments 216 to moderators 250, optionally via network 206. The moderators may exclude or otherwise moderate the comments based on relevance, quality, or other factors, and moderated comments receiving software 252 executing on processor 204 operates to receive moderated comments 254 from moderators 250, optionally via network 206.

Moderated comments transmission software 256 executing on processor 204 operates to transmit moderated comments 254 to all members of the population 208 via network 206.

Sampling software 220 executing on processor 204 operates to identify a sample 222 from among the population 208 via network 206. Sample 222 is a subset of population 208 and may represent a randomized sample. Optionally, sample 222 is calculated using simple random sampling, or other suitable sampling methods known in the art. Alternatively, the sample may be identified manually, or through other means.

Ratings receiving software 224 executing on processor 204 operates to receive ratings 226 from members of the sample 222 regarding moderated comments 254 via network 206. Optionally, ratings 226 assign a priority to one or more of the moderated comments 254 and may relate to the relevance, credibility, or other qualities of a given comment.

Ratings transmission software 228 executing on processor 204 operates to transmit the ratings 226 to the population 208 via network 206.

Filtering the commentary of the entire population through trained moderators in the manner of system 200 can have the advantage of enhancing the relevancy of the commentary and reducing the analysis burden on both the population and the sample, enhancing the effectiveness of debate.

Providing commentary from experts in the manner of system 200 can have the advantage of increasing the knowledge base of the population, resulting in more informed decision making and more informed commentary on the information.

Also, as in system 100, using a randomized sample of a larger population to rate the commentary of the entire population in the manner of system 200 can have the advantage of allowing all members of the population to be heard in a debate, while keeping the representativeness of their views in perspective.

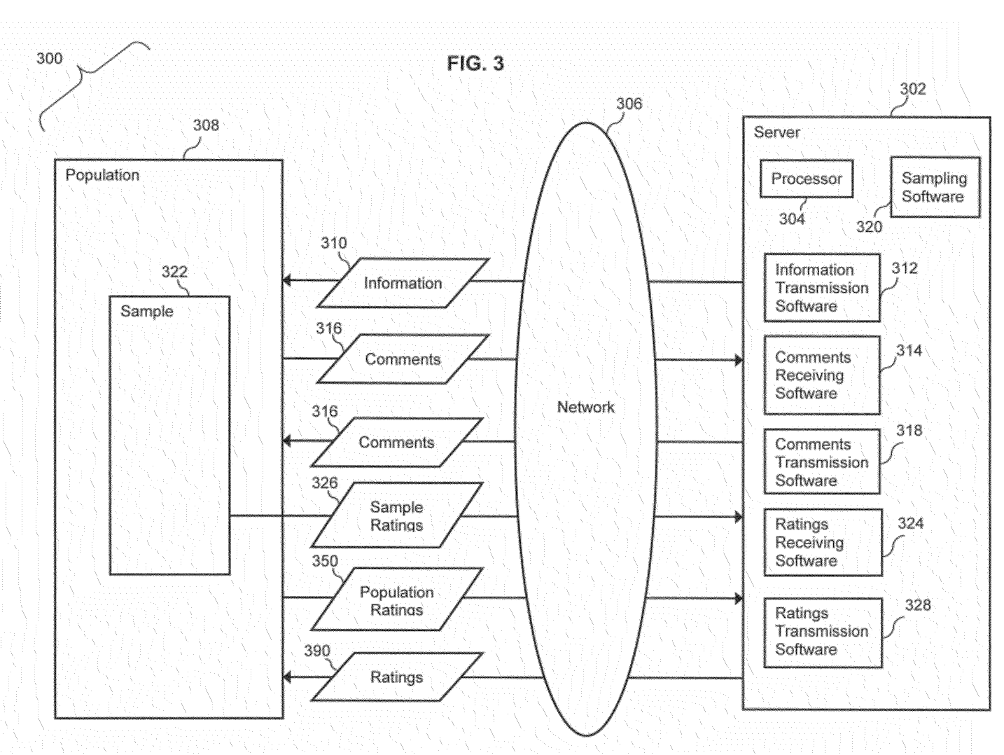

FIG. 3 illustrates an example system 300 according to aspects of the invention. System 300 is similar to systems 100 and 200 above, except in that it incorporates comment rating by both the sample and the population, which may be represented separately.

System 300 includes a server 302 connected to a computer communications network 306. Server 302 comprises one or more computing devices having at least one processor 304, and one or more databases (not shown) embodied as hard disk drives, flash memory drives, storage arrays, and the like. The server 302 is accessible over a communications network 306, such as the internet, by one or more client computers (not shown). It will be understood by those having skill in the art that variations of this arrangement can be used to construct system 300.

Server 302 operates to provide access by a population 308 to information 310 using the one or more client computers (not shown), via network 306. Information 310 may be any information that can be the subject of debate. In one illustrative example according to the invention, information 310 includes a briefing document which contains one or more proposals for debate, and may contain arguments in favor of or against these proposals.

Information transmission software 312 executing on processor 304 operates to transmit the information 310 to the population 308 via network 306.

Comments receiving software 314 executing on processor 304 operates to receive comments 316 from members of the population 308 regarding information 310 via network 306. Optionally, the comments 316 may pertain to the information 310, and may be related to specific portions of the information through the operation of comments receiving software 316 or other software (not shown) executing on processor 304. For example, a particular comment may be related to a particular proposal, or to a particular argument for or against a proposal, or may be addressed generally to the information or to portions or sections of the information 310.

Comments transmission software 318 executing on processor 304 operates to transmit comments 316 to all members of the population 308 via network 306.

Sampling software 320 executing on processor 304 operates to identify a sample 322 from among the population 308 via network 306. Sample 322 is a subset of population 308 and may represent a randomized sample. Optionally, sample 322 is calculated using simple random sampling, or other suitable sampling methods known in the art. Alternatively, the sample may be identified manually, or through other means.

Ratings receiving software 324 executing on processor 304 operates to receive sample ratings 326 from members of the sample 322 regarding comments 316 via network 306. Optionally, sample ratings 326 assign a priority to one or more of the comments 316 and may relate to the relevance, credibility, or other qualities of a given comment.

Ratings receiving software 324 may also operate to receive population ratings 350 from members of the population 308. Optionally, population ratings 350 are similar to sample ratings 326, assign a priority to one or more of the comments 316, and may relate to the relevance, credibility, or other qualities of a given comment.

Ratings transmission software 328 executing on processor 304 operates to transmit ratings 390 (which may include both sample ratings 326 and population ratings 350) to the population 308 via network 306. Optionally, sample ratings 326 and population ratings 350 may be presented to the population separately.

As in systems 100 and 200, using a randomized sample of a larger population to rate the commentary of the entire population in the manner of system 200 can have the advantage of allowing all members of the population to be heard in a debate, while keeping the representativeness of their views in perspective.

Further, presenting the ratings of both a randomized sample which has deliberated beforehand, as well as the entire population can have the advantage of enabling the population, as well as researchers, to evaluate the effects of increased mobilization on different threads of commentary on the information.

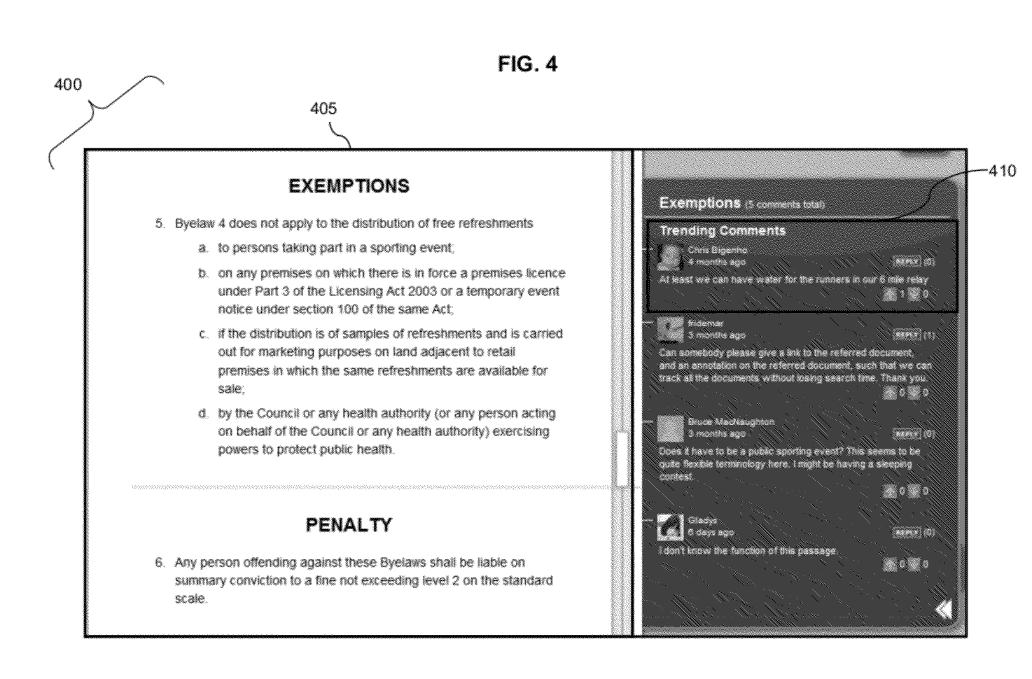

FIG. 4 illustrates an example display 400 which may be received by a population according to aspects of the invention. In the example systems described with respect to FIGS. 1-3, various information as well as comments and ratings are transmitted to the population via a network. Members may receive this information, for example, via a client computer in communication with the network. Display 400 illustrates an example presentation of these various data as delivered to the population as delivered via a commenting interface. Information 405 may comprise for example, a briefing document containing various sections or paragraphs. Comment 410 is displayed and may pertain to the information 405 or portions of information 405. Comment 410 may be related to specific portions of the information, for instance, through the use of a leader line 415 or other suitable indicator.

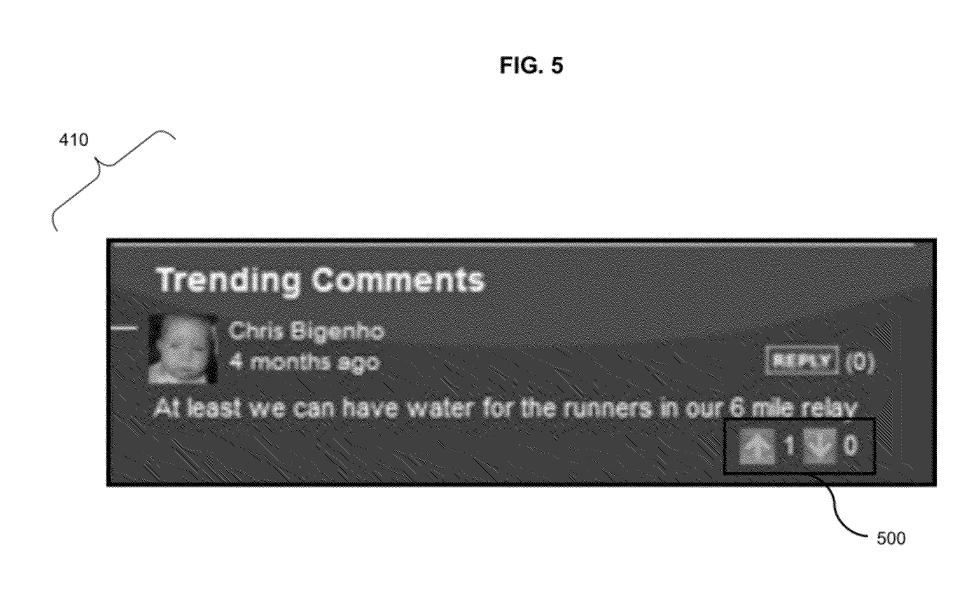

FIG. 5 is an enlarged view of comment 410, showing an example rating 500 associated with comment 410. Rating 500 may assign a priority to one or more of the comments 216 and may relate to the relevance, credibility, or other qualities of a given comment. Rating 500 may have been provided by members of the population, or by members of a sample of the population, as further elaborated with respect to FIGS. 1-3. Optionally, more than one rating may be supplied (not shown) reflecting a separate rating from the sample and from the population as a whole, or from other suitable selected groups.

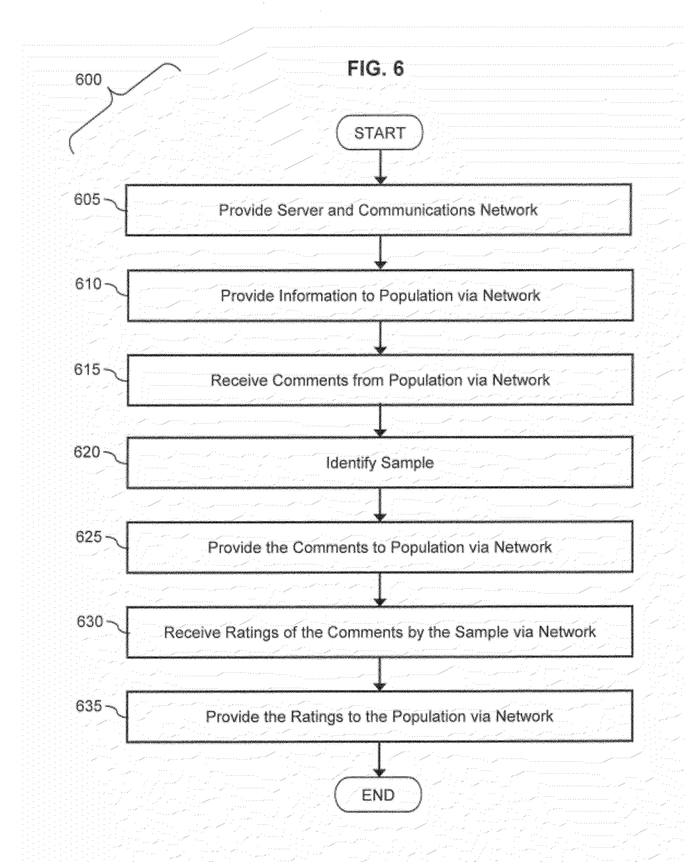

FIG. 6 illustrates an example method 600 for reducing the impact of a disproportionally mobilized faction on a deliberative process according to aspects of the invention.

In step 605, a computer server is provided connected to a computer communications network. The computer server comprises a processor and storage media, which may be tangible, non-transient storage media, as well as software executing on the processor. A population can access the computer server via the computer communications network. Optionally, access is from one or more client computers, and can take place via an interactive web-interface.

In step 610, information is provided to the population via software executing on the server, over the communications network. In one illustrative example according to the invention, information includes a briefing document which contains one or more proposals for debate, and may contain arguments in favor of or against these proposals.

In step 615, comments relating to the information are received from members of the population, via software executing on the server, over the communications network. Optionally, the comments may pertain to the information, and may be related to specific portions of the information through the operation of comments receiving software or other software (not shown) executing on the server. For example, a particular comment may be related to a particular proposal, or to a particular argument for or against a proposal, or may be addressed generally to the information or to portions or sections of the information.

In step 620, a sample from among the population is identified. The sample is a subset of the population and may be a randomized sample such as a simple random sample, or other suitable sample known in the art. Optionally, the sample is identified via software executing on the server.

In step 625, the comments received from the members of the population are provided to all members of the population via software executing on the processor, over the communications network.

In step 630, members of the sample provide ratings of the comments which are received via software executing on the server over the network. The ratings may prioritize the comments, and may relate to the relevance, quality, or other aspects of the comments.

In step 635, the ratings provided by members of the sample are provided to all members of the population via software executing on the server, over the communications network.

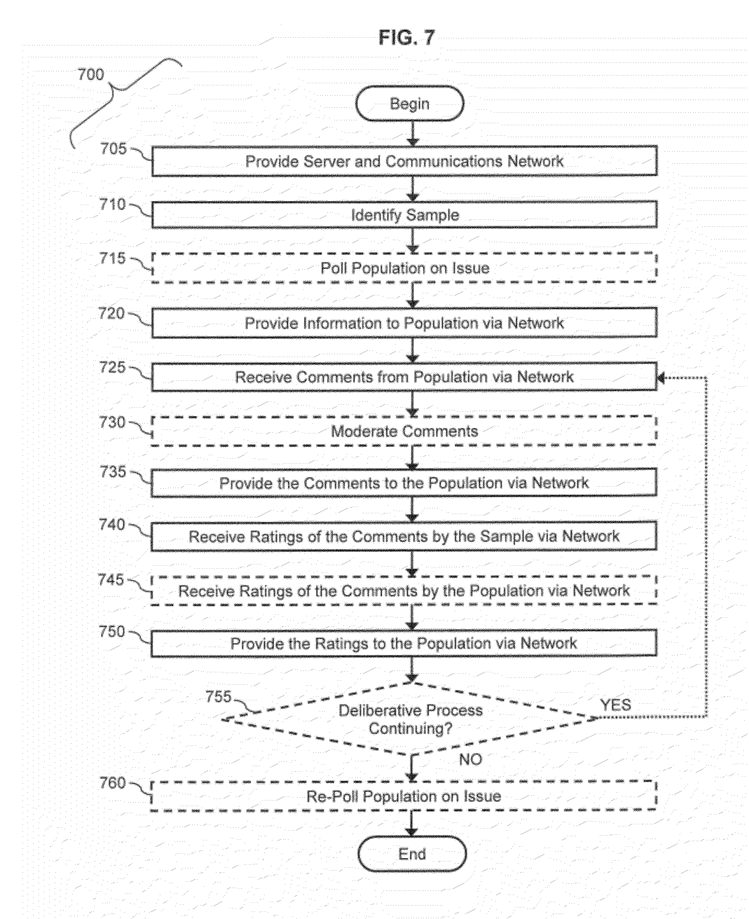

FIG. 7 illustrates another example method 700 for reducing the impact of a disproportionally mobilized faction on a deliberative process according to aspects of the invention.

In step 705, a computer server is provided connected to a computer communications network. The computer server comprises a processor and storage media, which may be tangible, non-transient storage media, as well as software executing on the processor. A population can access the computer server via the computer communications network. Optionally, access is from one or more client computers, and can take place via an interactive web-interface.

In step 710, a sample from among the population is identified. The sample is a subset of the population and may be a randomized sample such as a simple random sample, or other suitable sample known in the art. Optionally, the sample is identified via software executing on the server.

In an optional step 715, the population is polled on an issue. Polling can take place via software executing on the server, over the communications network.

In step 720, information is provided to the population via software executing on the server, over the communications network. In one illustrative example according to the invention, information includes a briefing document which contains one or more proposals for debate, and may contain arguments in favor of or against these proposals.

In step 725, comments relating to the information are received from members of the population, via software executing on the server, over the communications network. Optionally, the comments may pertain to the information, and may be related to specific portions of the information through the operation of comments receiving software or other software (not shown) executing on the server. For example, a particular comment may be related to a particular proposal, or to a particular argument for or against a proposal, or may be addressed generally to the information or to portions or sections of the information.

In an optional step 730, the comments are moderated. Moderators receive the comments from the server, optionally via the network. The moderators may exclude or otherwise moderate the comments based on relevance, quality, or other factors, and moderated comments receiving software executing on the server operates to receive moderated comments from the moderators, optionally via the network.

In step 735, the comments received from the members of the population are provided to all members of the population via software executing on the processor, over the communications network.

In step 740, members of the sample provide ratings of the comments which are received via software executing on the server over the network. The ratings may prioritize the comments, and may relate to the relevance, quality, or other aspects of the comments.

In an optional step 745, members of the population provide ratings of the comments which are received via software executing on the server over the network. The ratings may prioritize the comments, and may relate to the relevance, quality, or other aspects of the comments.

In step 750, the ratings are provided to all members of the population via software executing on the server, over the communications network.

While the deliberative process is continuing 755, the comments and ratings may be continually updated in real time for the duration of a deliberative process.

In an optional step 760, the population may be re-polled on the issue after the conclusion of the deliberative process. Polling can take place via software executing on the server, over the communications network.

Aspects of the invention may be expressed by other deliberative processes that facilitate the legitimacy of decisions in a community. That community could be the employees of a corporation or government agency, the members of an association or a specific community of the mass public. Such processes include the combination of a Deliberative Poll (in-person or online, as further described below) and:

(a) online discussion (that is refined and enlarged by the Deliberative Polling discussion) in the entire broader Community of Responsibility;

(b) in-person or online discussion in the entire broader Community of Responsibility, where the Community of Responsibility is broken into small groups

(c) process (a) followed by process (b)

These processes may also include online discussion rated by a random sample in the entire broader Community of Responsibility; followed by in-person or online discussion in the entire broader Community of Responsibility, where the Community of Responsibility is broken into small groups.

Such an example process may include a number of steps:

The leadership of the company, government agency, society or association sponsoring the process will identify a topic for a Deliberative Society Implementation. The company, government agency, association or society will be referred to as the Community of Responsibility and that Community will identify a Population affected by or concerned with the results of the process.

A Committee will be formed of individuals of diverse opinions. It is important that this be a balanced group consisting of different representative points of view. Typically, this committee is an advisory committee of “stakeholders.”

The Committee will agree on the contents of a briefing document, supervising its contents for balance and accuracy. The briefing document will identify arguments in favor and against multiple concrete proposals for making changes in policy affecting the Community. Typically it will contain data, empirical assumptions, risks, advantages and disadvantages of each approach.

A survey of close ended questions will be drafted that will identify initial opinions about different policy options.

A scientific sample of the Population, large enough for the evaluation of its representativeness and opinion changes to be statistically meaningful, will be selected.

The sample will be polled on the issues.

Upon completing the survey, the random sample will receive the briefing materials prepared by the committee.

Moderators will be trained for in-person discussions or for online discussions.

Upon receipt of the briefing materials, the random sample will be brought together, either physically or in virtual space, to deliberate in small groups with trained moderators. They will discuss the issues and ask questions of experts, who will be brought in to discuss the goals and options.

After one-and-a-half, three days, one week, one month or three months of deliberation (or some other specified period), the scientific sample will be polled again. Their level of opinion change will be quantified for an analysis component.

These discussions may or may not be recorded on video and edited.

If videos are created, they will be distributed along with the analysis of the poll results to all members of the Community of Responsibility.

Specific comments from the video may be clipped for inclusion as comments in portions of the briefing materials prepared for the next stage of the deliberation.

This content, including the videos, policy proposals and briefing materials, will be discussed online using the technology.

Comments will be moderated by trained professionals. These moderators will be trained.

Experts will respond to comments. They will be trained to do so factually.

Comments will be rated by the random sample to prioritize them. This is important because it prevents any small, mobilized faction from manipulating the process by mobilizing disproportionate participation by that faction.

The results of the sample's deliberations will be used to formulate revised proposals that will be sent to all members of the population online for discussion.

These comments and the results of the sample's deliberations will then be used to prepare all members of the broader Community of Responsibility for small group discussions. These discussions open to participation by the entire Community of Responsibility and will be moderated by professionals who are trained for the process. These discussions can occur either in-person or in virtual space.

The Population will continue to add comments, possibly in real-time during in-person discussions.

These comments will be prioritized based on both the ratings from all Community of Responsibility members and the ratings from the random sample.

The entire population will be organized to participate in small group discussions, with before and after questionnaires (similar to the first round with the scientific sample, but revised in light of the most recent results and discussions). The discussions in small groups will be moderated and they will include the possibility of questions to competing diverse experts

At the end of the deliberations open to the entire population, the before and after poll results for that population will be analyzed and made available to the community for its decisions.

Depending on the nature of the Community of Responsibility, decisions will likely be taken based on the results of this process, whether policies that will be passed internally if the entity is a corporation, professional standards in the case of a professional association, law or regulation in the case of a government.

It will be understood by those having skill in the art that software may comprise a computer-readable medium having stored thereon sequences of instructions, the sequences of instructions including instructions, when executed by a processor, cause the processor to perform a given action.

Although the invention has been described with reference to a particular arrangement of parts, features and the like, these are not intended to exhaust all possible arrangements or features, and indeed many modifications and variations will be ascertainable to those of skill in the art.

What is claimed is:

1. A method for reducing the impact of a disproportionally mobilized faction on a deliberative process comprising the steps of:
providing a server comprising a processor and connected to a communications network;
identifying a sample of a population;
providing information to the sample, via software executing on the server, over the communications network;
deliberating, by the sample, about the information;
providing the information to the population, via software executing on the server, over the communications network;
receiving comments relating to the information from members of the population, via software executing on the server, over the communications network;
providing the comments to the population, via software executing on the server, over the communications network;
receiving ratings of the comments from members of the sample, via software executing on the server, over the communications network; and,
providing the ratings to the population, via software executing on the server, over the communications network.

2. The method of claim 1, wherein the ratings are priority ratings.

3. The method of claim 1, wherein the sample is a randomized sample.

4. The method of claim 1, wherein the communications network is the Internet.

5. The method of claim 1, wherein the deliberations comprise an informed deliberation or Deliberative Poll.

6. The method of claim 1, wherein the comments are annotations to the information.

7. The method of claim 1, wherein the step of generating a sample of the population is performed via software executing on the server.

8. The method of claim 1, wherein the information is a document.

9. The method of claim 1, wherein the information, comments, and ratings are provided to and received from the population using an interactive webpage.

10. The method of claim 1, wherein the comments and ratings are continually updated in real time for the duration of a deliberative process.

11. The method of claim 10, wherein the deliberative process is an online forum or debate.

12. The method of claim 1, further comprising receiving second ratings of the comments by members of the population via the communications network; and, providing the second ratings to the population via the communications network.

13. The method of claim 1, further comprising moderating the received comments from members of the population, prior to providing the comments to the population.

14. The method of claim 1, wherein the information is a document which has been developed by a committee and refined by deliberation of the sample prior to providing the information to the population.

15. The method of claim 1, further comprising polling the population on an issue, via the communications network, prior to providing the information;
re-polling the population on the issue, via the communications network, after providing the comments and ratings to the population.

16. A system for reducing the impact of a disproportionally mobilized faction on a deliberative process comprising:
a computer communications network;
a computing device having a processor, the computing device being connected to the computer network;
information transmission software executing on the processor, providing information to a population, via the computer network;
comments receiving software executing on the processor, receiving comments from members of the population relating to the information, via the computer network;
sampling software executing on the processor, identifying a sample of the population;
comments transmission software executing on the processor, transmitting the comments to the sample, via the computer network;
ratings receiving software executing on the processor, receiving ratings of the comments by the sample, via the computer network;
ratings transmission software executing on the processor, transmitting the ratings to the population, via the computer network.

17. The system of claim 14, wherein the comments are moderated prior to transmitting the comments to the sample.

18. The system of claim 14, wherein the comments receiving software also receives comments from experts relating to the information, via the computer network.

19. The system of claim 14, further comprising population ratings receiving software executing on the processor, receiving ratings of the comments from the population, via the computer network; and,
population ratings transmission software executing on the processor, transmitting the population ratings to the population, via the computer network.

20. The system of claim 14, further comprising
polling software executing on the processor, polling the population on an issue prior to providing information to the population, via the computer network; and,
polling software executing on the processor, re-polling the population on the issue after providing the comments and ratings to the population, via the computer network.

21. The system of claim 14, wherein the sampling software identifies a randomized sample of the population.

22. The system of claim 14, wherein the information, comments, and ratings are provided to and received from the population using an interactive webpage.

23. A method for reducing the impact of a disproportionally mobilized faction on a deliberative process comprising the steps of:
providing a server comprising a processor and connected to a communications network;
identifying a topic for a Deliberative Society Implementation, by the leadership of a community comprising a company, government agency, society or association sponsoring a deliberative process, identifying a population affected by or concerned with the results of the process;
forming a committee of individuals of diverse opinions consisting of different representative points of view;
agreeing, by the committee, on the contents of a briefing document, supervising its contents for balance and accuracy, such that it identifies arguments in favor and against multiple concrete proposals for making changes in policy affecting the community, and contains data, empirical assumptions, risks, advantages and disadvantages of each approach;
drafting a survey of close ended questions that will identify initial opinions about different policy options.
selecting a scientific sample of the population, large enough for the evaluation of its representativeness and opinion changes to be statistically meaningful;
polling the sample on the contents via software executing on the server, over the communications network;
transmitting the briefing documents to the sample upon the sample completing the survey via software executing on the server, over the communications network;
training the sample for in-person discussions or for online discussions;
bringing together the random sample, upon receipt of the briefing materials, either physically or in virtual space, to deliberate in small groups with trained moderators regarding the contents and ask questions of experts, who will be brought in to discuss the goals and options;
re-polling the sample on the contents after one-and-a-half, three days, one week, one month or three months of deliberation, to quantify their level of opinion change via software executing on the server, over the communications network;
recording the deliberations on video and editing the video;
distributing the video, along with the analysis of the poll results, to all members of the community via software executing on the server, over the communications network;
identifying comments from the video for inclusion as comments in portions of updated briefing materials;
discussing, by the sample, the videos, policy proposals and briefing materials online via software executing on the server, over the communications network;
moderating the comments, by trained moderators via software executing on the server, over the communications network;
responding to comments, by experts who are trained to do so factually via software executing on the server, over the communications network;
rating the comments, by the random sample, to prioritize them via software executing on the server, over the communications network;
formulating revised proposals using the results of the sample's deliberations;
preparing all members of the community for small group discussions using the comments and the results of the sample's deliberation;
discussing, either in-person or in virtual space, by the community, the revised proposals;
moderating the discussion of the revised proposals via software executing on the server, over the communications network;
commenting in real-time during the discussion of the revised proposals, by the population via software executing on the server, over the communications network;
prioritizing the comments by the population based on both the ratings from the community members and the ratings from the random sample via software executing on the server, over the communications network;
organizing the community to participate in moderated small group discussions with before-and-after questionnaires and the possibility of questions to experts having diverse opinions via software executing on the server, over the communications network;
analyzing the poll results for the community at the end of deliberation and making the results available to the community for its decisions via software executing on the server, over the communications network.
